(19) United States
(12) Patent Application Publication
(10) Pub. No.: US 2025/0007071 A1
(43) Pub. Date: Jan. 2, 2025

(54) ENERGY STORAGE SYSTEM

(71) Applicant: SAMSUNG SDI CO., LTD., Yongin-si (KR)

(72) Inventor: Dae Su KIM, Suwon-si (KR)

(21) Appl. No.: 18/623,711

(22) Filed: Apr. 1, 2024

(30) Foreign Application Priority Data
Jun. 30, 2023 (KR) 10-2023-0084877

(51) Int. Cl. H01M 50/262; H01M 50/204; H01M 50/383

(52) U.S. Cl. CPC H01M 50/262; H01M 50/204; H01M 50/383; H01M 2200/10

(57) ABSTRACT

An energy storage system includes: a rack frame accommodating battery modules; a sub-frame secured to the rack frame and facing a battery module of the battery modules; a guide rail concavely formed on a surface of the sub-frame; a fire extinguishing pipe arranged within the guide rail and including a spray hole through which a fire extinguishing liquid is sprayable; a heat detection member configured to surround the fire extinguishing pipe and open or close the spray hole in conjunction with a temperature variation; and a first anti-detachment member arranged between the guide rail and the heat detection member to prevent the fire extinguishing pipe from being detached from the guide rail.

### CROSS-REFERENCE TO RELATED APPLICATION

The present application claims priority to and the benefit of Korean Patent

Application No. 10-2023-0084877, filed on Jun. 30, 2023 in the Korean Intellectual Property Office, the entire disclosure of which is incorporated herein by reference.

### BACKGROUND

### 1. Field

Aspects of embodiments of the present disclosure relate to an energy storage system.

### 2. Description of the Related Art

In general, an energy storage system is a device capable of storing surplus electricity or electricity generated using renewable energy. A plurality of racks each accommodating a plurality of battery modules therein may be received in a container. The battery module may include a plurality of secondary batteries electrically interconnected to each other and arranged in various structures.

The energy storage system may be provided with a direct spray system for

spraying a fire-extinguishing liquid directly onto the battery modules in the event of a fire. Such a direct spray system may be implemented by placing a fire extinguishing pipe capable of spraying the fire-extinguishing liquid onto the battery modules. However, if the fire extinguishing pipe is rotated or detached from a correct position, the fire-extinguishing liquid can be sprayed in a direction different from a preset spray direction, thereby making it difficult to quickly extinguish the fire and causing damage to the fire extinguishing pipe due to interference with the battery modules.

### SUMMARY

According to an aspect of embodiments of the present disclosure, an energy storage system capable of holding a fire extinguishing pipe in position is provided. The above and other aspects and features of the present disclosure will be described in or will be apparent from the following description of some embodiments of the present disclosure.

According to one or more embodiments of the present disclosure, an energy storage system includes: a rack frame accommodating battery modules; a sub-frame secured to the rack frame and facing a battery module of the battery modules; a guide rail concavely formed on a surface of the sub-frame; a fire extinguishing pipe arranged within the guide rail and including a spray hole through which a fire extinguishing liquid is sprayable; a heat detection member configured to surround the fire extinguishing pipe and open or close the spray hole in conjunction with a temperature variation; and a first anti-detachment member arranged between the guide rail and the heat detection member to prevent the fire extinguishing pipe from being detached from the guide rail.

The first anti-detachment member may include a slit formed through the guide rail; and a stopper protruding from the heat detection member toward the slit and inserted in the slit.

The stopper may have a smaller width than the slit.

The slit may include a plurality of slits symmetrically arranged at opposite

sides of the guide rail, and the stopper may include a plurality of stoppers symmetrically arranged at opposite sides of the heat detection member.

The fire extinguishing pipe may be inserted in the guide rail through an open surface formed on the guide rail in a first direction, and the slit may include a first slit extending in the first direction; and a second slit connected to the first slit and extending in a direction intersecting the first direction.

The first slit may include: a first end connected to the second slit; and a second end placed at an opposite side of the first end and penetrating the sub-frame.

The second slit may extend in a longitudinal direction of the guide rail.

The second slit may have a smaller width than the first slit.

The first anti-detachment member may include a groove concavely formed on an outer surface of the heat detection member, and a stopper protruding from the guide rail and inserted in the groove.

The groove may include a plurality of grooves symmetrically arranged at opposite sides of the heat detection member, and the stopper may include a plurality of stoppers symmetrically arranged at opposite sides of the guide rail.

The stopper may have a smaller width than the groove.

The groove may extend in a longitudinal direction of the heat detection member.

The groove may have a smaller length than the heat detection member.

An end of the groove may penetrate an end of the heat detection member.

The energy storage system may further include a second anti-detachment member arranged outside the guide rail to face the heat detection member.

The first anti-detachment member may be spaced apart from the second anti-detachment member in a longitudinal direction of the guide rail.

The second anti-detachment member may include a plurality of second anti-detachment members arranged at opposite sides of the guide rail.

The fire extinguishing pipe may be inserted in the guide rail through an open surface formed on the guide rail in a first direction, and the open surface may face the second anti-detachment member in the first direction.

The second anti-detachment member may extend from the sub-frame in a direction intersecting the first direction.

In the energy storage system according to one or more embodiments of the present disclosure, the first anti-detachment member restricts rotation of the fire extinguishing pipe about a central axis thereof within the guide rail, thereby preventing (preventing or substantially preventing) a change of a spray direction of the spray hole while securing reliability in fire suppression performance.

In the energy storage system according to one or more embodiments of the present disclosure, the first anti-detachment member prevents (prevents or substantially prevents) the fire extinguishing pipe from being detached from the guide rail, thereby preventing (preventing or substantially preventing) damage to the fire extinguishing pipe due to interference with the battery module mounted on the sub-frame.

In the energy storage system according to one or more embodiments of the present disclosure, the second anti-detachment member can prevent (prevent or substantially prevent) the fire extinguishing pipe from being detached from the guide rail when the first anti-detachment member loses an inherent function thereof due to damage to the stopper.

### BRIEF DESCRIPTION OF THE DRAWINGS

The following drawings attached to this specification illustrate some embodiments of the present disclosure, and further describe aspects and features of the present disclosure together with the detailed description of the present disclosure. However, embodiments of the present disclosure should not be construed as being limited to the drawings.

FIG. 1 is a schematic perspective view of an energy storage system according to an embodiment of the present disclosure.

FIG. 2 is a schematic perspective view of a sub-frame and a guide rail according to an embodiment of the present disclosure.

FIG. 3 is another schematic perspective view of the sub-frame and the guide rail according to an embodiment of the present disclosure.

FIG. 4 is a schematic perspective view of a fire extinguishing pipe and a heat detection member according to an embodiment of the present disclosure.

FIG. 5 is another schematic perspective view of the fire extinguishing pipe and the heat detection member according to an embodiment of the present disclosure.

FIG. 6 is a schematic perspective view of a first anti-detachment member according to an embodiment of the present disclosure.

FIG. 7 is a schematic exploded perspective view of the first anti-detachment member according to an embodiment of the present disclosure.

FIG. 8 is a schematic plan view of the first anti-detachment member according to an embodiment of the present disclosure.

FIG. 9 is a schematic front view of the first anti-detachment member according to an embodiment of the present disclosure.

FIG. 10 to FIG. 12 are schematic views illustrating a process of assembling the fire extinguishing pipe to the guide rail in the energy storage system according to an embodiment of the present disclosure.

FIG. 13 is a view illustrating a state in which an external force is applied to the fire extinguishing pipe shown in FIG. 12.

FIG. 14 is a schematic exploded perspective view of a first anti-detachment member according to another embodiment of the present disclosure.

FIG. 15 is a schematic plan view of the first anti-detachment member shown in FIG. 14.

FIG. 16 to FIG. 18 are schematic views illustrating a process of assembling the fire extinguishing pipe to the guide rail in the energy storage system according to the embodiment shown in FIG. 14.

FIG. 19 is a view illustrating a state in which an external force is applied to the fire extinguishing pipe shown in FIG. 18.

### DETAILED DESCRIPTION

Herein, some embodiments of the present disclosure will be described in further detail with reference to the accompanying drawings. The terms or words used in this specification and claims should not be construed as being limited to the usual or dictionary meaning and should be interpreted to have a meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are provided as some embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s), referring to the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the example term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly connected to another part or one or more intervening parts may be present therebetween such that the part and another part are indirectly connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

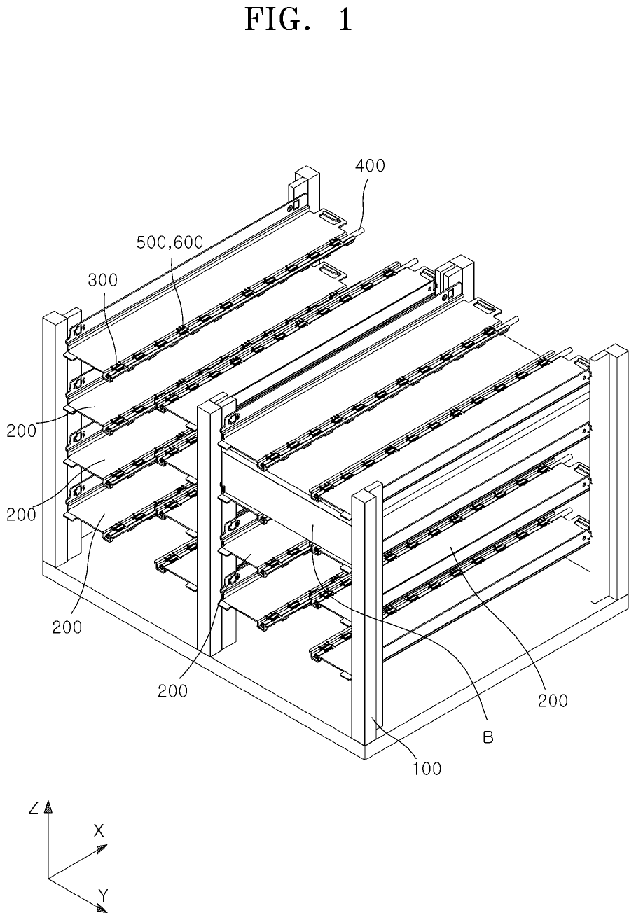

FIG. 1 is a schematic perspective view of an energy storage system according to an embodiment of the present disclosure.

Referring to FIG. 1, the energy storage system according to an embodiment includes a rack frame 100, a sub-frame 200, a guide rail 300, a fire extinguishing pipe 400, a heat detection member 500, and a first anti-detachment member 600.

The rack frame 100 is provided therein with a space capable of accommodating battery modules B. According to an embodiment, the rack frame 100 may have a hollow box or frame shape. The rack frame 100 may be disposed in a building, a container, a cabinet, or the like. The rack frame 100 may be formed of a material with high stiffness, such as steel or the like, to prevent (prevent or substantially prevent) breakage due to a load applied from the battery modules B. Although FIG. 1 shows the rack frame 100 having a parallelepiped shape, it is to be understood that the rack frame 100 may be modified into any of various shapes including a polyhedral shape, a cylindrical shape, and the like.

The battery module B stores power through charge/discharge operation, or supplies the stored power to an external electronic device (not shown). The battery module B may include a substantially box-shaped module case, a plurality of battery cells disposed within the module case, and a cooling plate through which a coolant flows to cool the battery cells. In an embodiment, the battery cells may be pouch-type secondary cells, prismatic secondary cells, or cylindrical secondary cells.

The battery module B may be provided in plural. A plurality of battery modules B may be stacked within the rack frame 100 in a vertical direction. That is, the plurality of battery modules B may be spaced apart from each other in a Z-axis direction with reference to FIG. 1. Further, the plurality of battery modules B may be arranged in plural rows in a horizontal direction. That is, the plurality of battery modules B may be arranged in plural rows in a Y-axis direction with reference to FIG. 1.

The sub-frame 200 is secured to the rack frame 100 and is disposed to face the battery module B. The sub-frame 200 may act to support the battery module B and the fire extinguishing pipe 400, described later, within the rack frame 100.

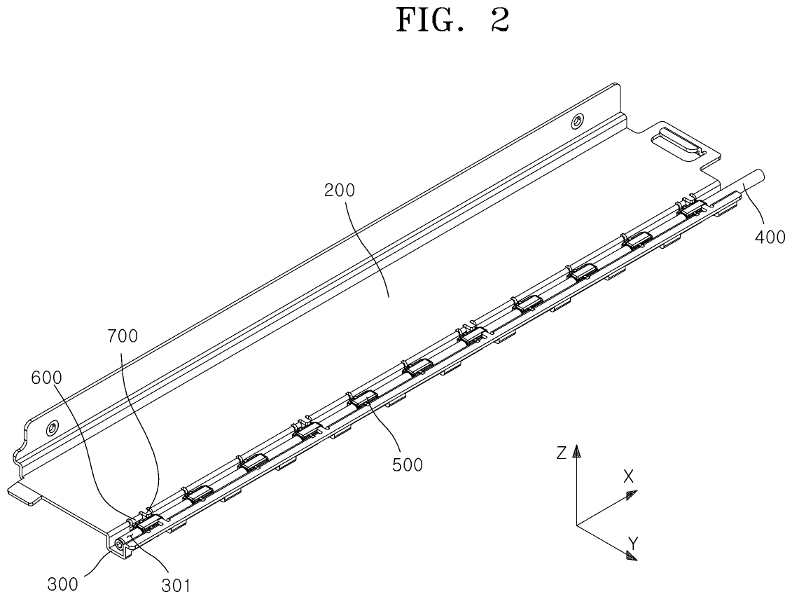

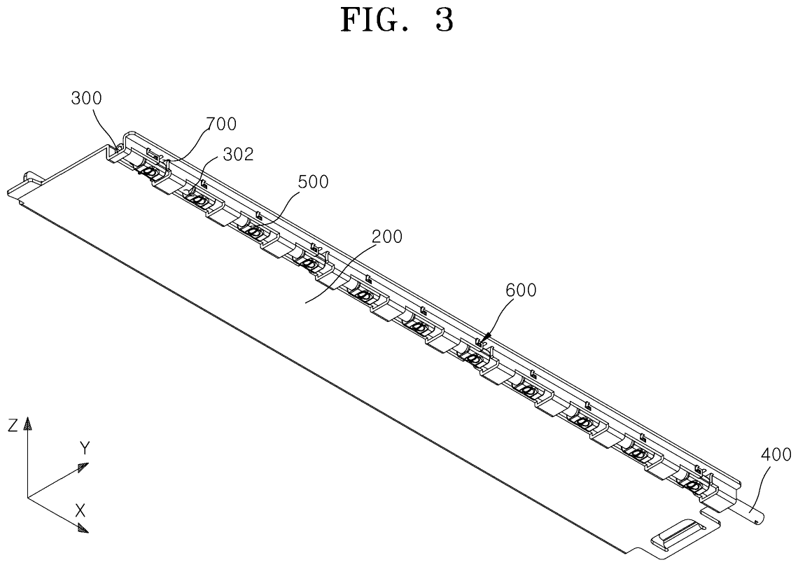

FIG. 2 is a schematic perspective view of the sub-frame 200 and the guide rail 300 according to an embodiment of the present disclosure; and FIG. 3 is another schematic perspective view of the sub-frame 200 and the guide rail 300 according to an embodiment of the present disclosure.

Referring to FIG. 1 to FIG. 3, the sub-frame 200 according to an embodiment may have a substantially plate shape. The sub-frame 200 may be provided in plural. Each of a plurality of sub-frames 200 may be disposed between a pair of battery modules B spaced apart in the vertical direction. In an embodiment, with reference to any one battery module B, the plurality of sub-frames 200 may be symmetrically disposed at opposite sides of the battery module B in a width direction thereof. Here, the width direction of the battery module B may mean a direction parallel to the Y-axis with reference to FIG. 1.

A lower surface of the sub-frame 200 disposed between the pair of battery modules B adjacent each other in the vertical direction may be spaced apart from an upper surface of a battery module B disposed at a lower side. In addition, an upper surface of the sub-frame 200 disposed between the pair of battery modules B adjacent each other in the vertical direction may contact a lower surface of the battery module B disposed at an upper side. Accordingly, each of the battery modules B may be supported within the rack frame 100, with the lower surface thereof seated on the sub-frame 200, and may secure a space on the upper surface thereof, to which a fire extinguishing liquid sprayed from the fire extinguishing pipe 400 described below can be delivered.

The guide rail 300 provides a space on the sub-frame 200, in which the fire extinguishing pipe 400 can be accommodated. The guide rail 300 according to an embodiment may be concavely formed on the upper surface of the sub-frame 200. The guide rail 300 may be disposed to have a longitudinal direction parallel to a longitudinal direction of the battery module B. Here, the longitudinal direction of the battery module B may refer to a direction parallel to an X-axis direction with reference to FIG. 1.

The guide rail 300 may be formed on an upper surface thereof with an open surface 301 through which an interior space of the guide rail 300 connects with an exterior space thereof. Accordingly, the guide rail 300 may have a cross-section enclosed by a pair of side surfaces, a bottom surface, and the open surface 301. Although FIG. 2 illustrates the guide rail 300 having a substantially rectangular cross-section, it is to be understood that the guide rail 300 is not limited thereto and may have any of various shapes, including a trapezoidal shape, a triangular shape, a semi-circular shape, and the like.

A lower surface of the guide rail 300 may be separated by a distance (e.g., a predetermined distance) from the upper surface of the battery module B to face the upper surface of the battery module B. The guide rail 300 may be formed on the lower surface thereof with a plurality of through-holes 302. The through-holes 302 may be vertically formed through the lower surface of the guide rail 300. Each of the through-holes 302 may be disposed at a position facing a vent hole (not shown) of each of battery cells in the battery module B.

The fire extinguishing pipe 400 is disposed within the guide rail 300 and delivers a fire extinguishing liquid.

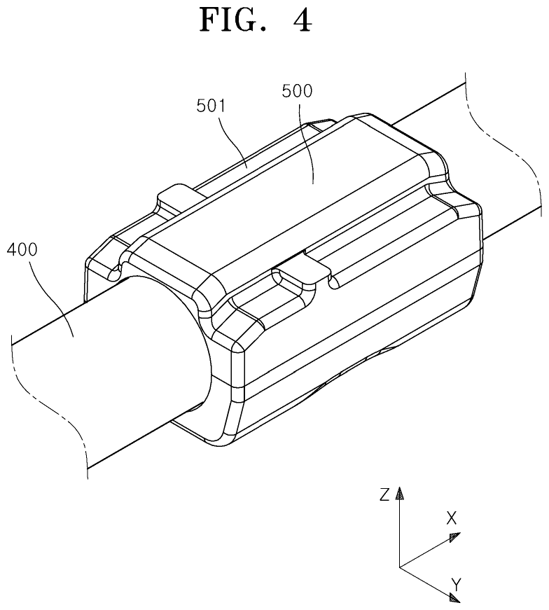

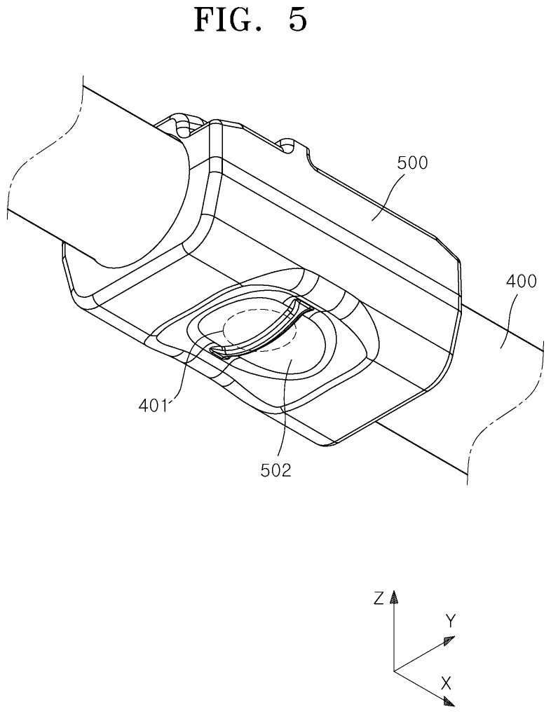

FIG. 4 is a schematic perspective view of the fire extinguishing pipe 400 and the heat detection member 500 according to an embodiment of the present disclosure; and FIG. 5 is another schematic perspective view of the fire extinguishing pipe 400 and the heat detection member 500 according to an embodiment of the present disclosure.

Referring to FIG. 1 to FIG. 5, the fire extinguishing pipe 400 according to an embodiment may have a hollow tube shape. The fire extinguishing pipe 400 may receive a fire extinguishing liquid supplied from the outside of the rack frame 100 via a separate hose, piping, or the like. Although FIG. 2 to FIG. 5 show the fire extinguishing pipe 400 having a circular cross-sectional shape, it is to be understood that the fire extinguishing pipe 400 may have any of various cross-sectional shapes.

The fire extinguishing pipe 400 may be disposed to have a longitudinal direction parallel to the longitudinal direction of the guide rail 300. The fire extinguishing pipe 400 may have a smaller cross-sectional area than the guide rail 300. The fire extinguishing pipe 400 may be inserted from the outside of the sub-frame 200 into the guide rail 300 through the open surface 301 in a first direction. Here, the first direction may refer to a direction parallel to the Z-axis among directions from the open surface 301 toward the interior of the guide rail 300. The fire extinguishing pipe 400 may be slidably moved in the longitudinal direction of the guide rail 300 in a state of being inserted into the guide rail 300.

The fire extinguishing pipe 400 may be provided in plural. A plurality of fire extinguishing pipes 400 may be disposed inside the guide rails 300, respectively.

The fire extinguishing pipe 400 may be formed with a spray hole 401 through which the fire extinguishing liquid is sprayed from the fire extinguishing pipe 400 to the outside of the fire extinguishing pipe 400. The spray hole 401 may be provided in plural. A plurality of spray holes 401 may be spaced apart from each other in the longitudinal direction of the fire extinguishing pipe 400. As the fire extinguishing pipe 400 is inserted into the guide rail 300, the spray holes 401 may be arranged to face the through holes 302, respectively.

The heat detection member 500 is disposed to surround the fire extinguishing pipe 400 and opens or closes the spray holes 410 in conjunction with a temperature variation.

According to an embodiment, the heat detection member 500 may be formed to surround an entire circumferential surface of the fire extinguishing pipe 400. However, a cross-sectional shape of the heat detection member 500 is not limited to the shape shown in FIG. 4 and FIG. 5, and may have any of various cross-sectional shapes so long as the heat detection member 500 can surround the circumferential surface of the fire extinguishing pipe 400. The heat detection member 500 may have a smaller cross-sectional area than the guide rail 300. Accordingly, the heat detection member 500 may guide the fire extinguishing pipe 400 to be smoothly inserted into the guide rail 300.

The heat detection member 500 may be provided in plural. A plurality of heat detection members 500 may be spaced apart from each other in the longitudinal direction of the fire extinguishing pipe 400. Each of the heat detection members 500 may be disposed to face a different spray hole 401. Accordingly, the heat detection member 500 may restrict the fire extinguishing liquid from being sprayed from the spray holes 401 in a normal temperature range.

When heated to a preset temperature or more, the heat detection member 500 may be melted and open the spray holes 401. Accordingly, in the event of a fire, the heat detection member 500 may open the spray holes 401 to induce the fire extinguishing liquid delivered along the fire extinguishing pipe 400 to be sprayed onto the upper surfaces of the battery modules B through the spray holes 401 and the through-holes 302. By way of example, the heat detection member 500 may be melted in a range of 80 degrees Celsius to 250 degrees Celsius. Here, 80 degrees Celsius may be a temperature at which the heat detection member 500 begins to melt, and 250 degrees Celsius may be a temperature at which the heat detection member 500 is completely melted. The heat detection member 500 may be formed of a resin material, such as any of ABS, PP, PC, PE, PFA, and the like.

When the fire extinguishing pipe 400 is inserted into the guide rail 300, a flat

seating surface 501 may be formed on a side, or an upper surface, of the heat detection member 500 that faces the open surface 301. In an embodiment, the seating surface 501 may be disposed parallel to the open surface 301 to face the open surface 301. The seating surface 501 may be provided as a pair of seating surfaces. The pair of seating surfaces 501 may be disposed at opposite sides of the heat detection member 500 in a width direction thereof, respectively.

A thin film 502 may be formed on another side, or a lower surface, of the heat detection member 500 that faces the spray hole 401. In an embodiment, the thin film 502 may have a smaller thickness than a remaining region of the heat detection member 500. For example, a region of the heat detection member 500 around the thin film 502 may have a thickness of 1 mm, and the thin film 502 may have a thickness of 0.3 mm to 0.6 mm or 0.2 mm to 0.9 mm. Accordingly, when heat is applied to the heat detection member 500, the thin film 502 may melt faster than the remaining region of the heat detection member 500 to allow the spray hole 401 to be quickly opened.

The first anti-detachment member 600 is disposed between the guide rail 300 and the heat detection member 500 and prevents (prevents or substantially prevents) the fire extinguishing pipe 400 from being detached from the guide rail 300. Further, the first anti-detachment member 600 may restrict the fire extinguishing pipe 400 from rotating about a center axis thereof inside the guide rail 300. Accordingly, the first anti-detachment member 600 can prevent (prevent or substantially prevent) the fire extinguishing pipe 400 from deviating from a correct position and changing a spray direction of the spray hole 401, and can prevent (prevent or substantially prevent) damage to the fire extinguishing pipe 400 through interference with the battery module B.

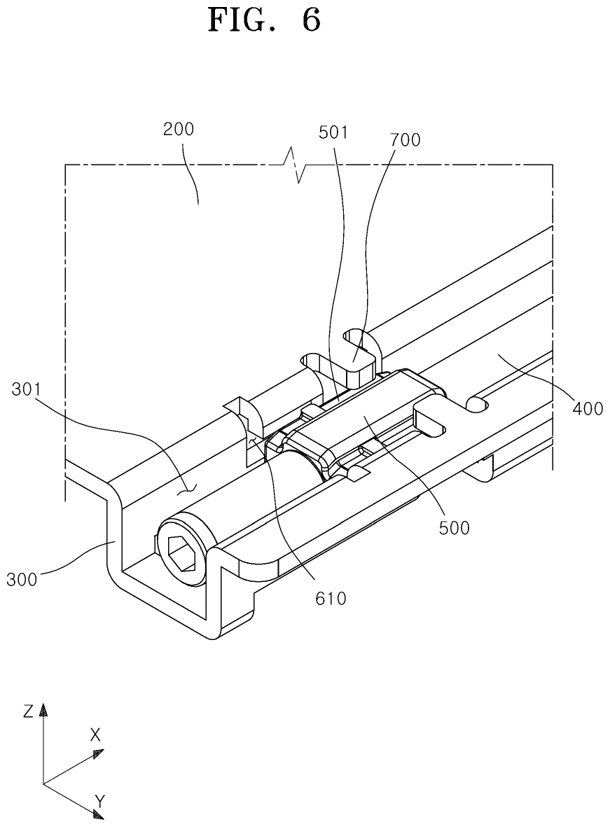

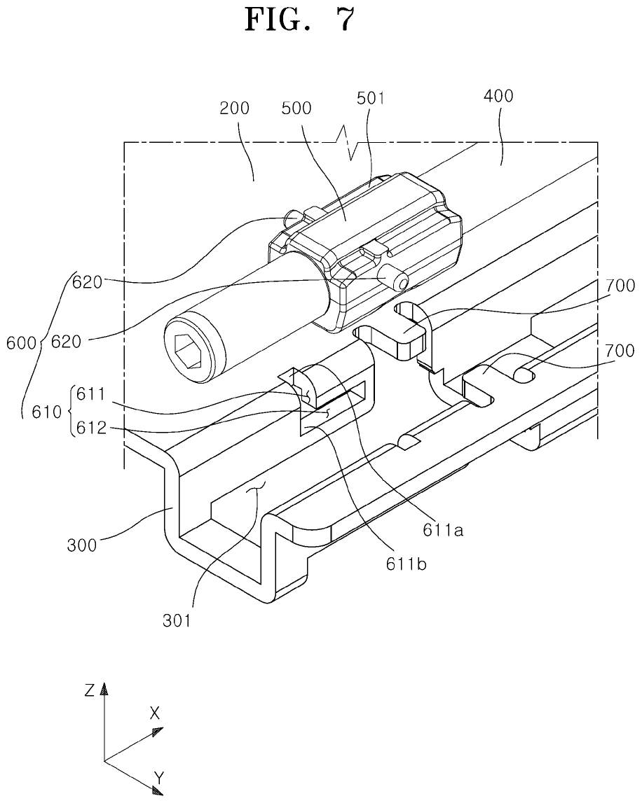

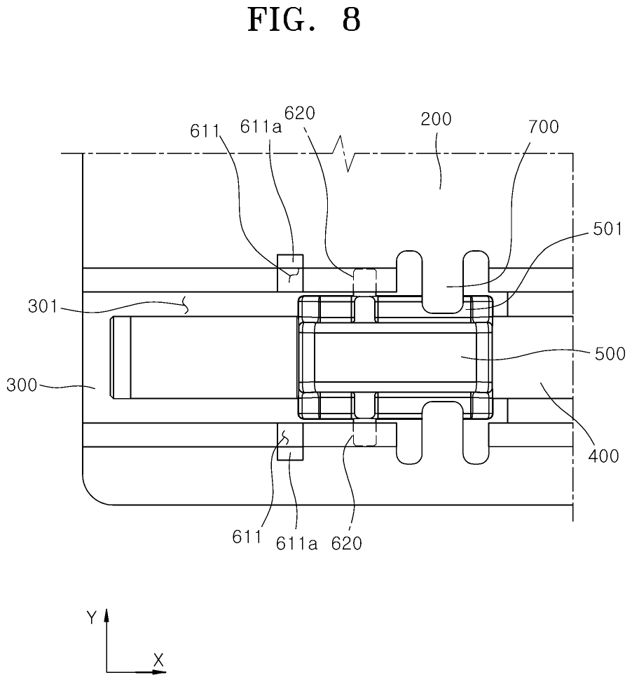

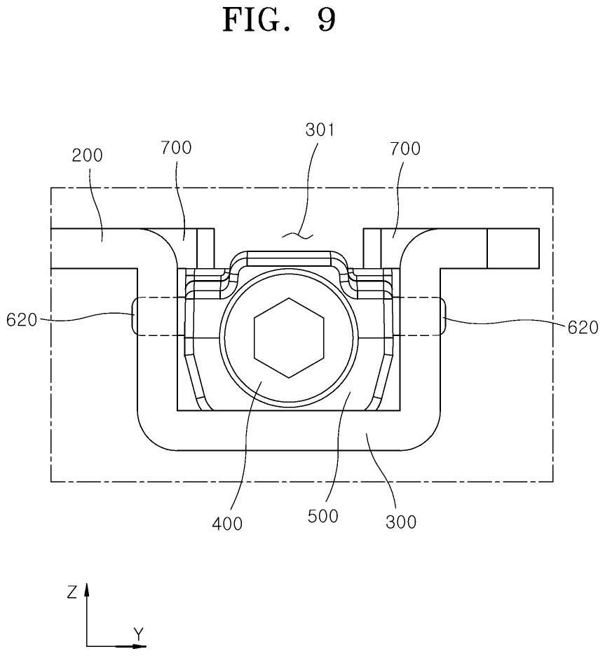

FIG. 6 is a schematic perspective view of the first anti-detachment member 600 according to an embodiment of the present disclosure; FIG. 7 is a schematic exploded perspective view of the first anti-detachment member 600 according to an embodiment of the present disclosure; FIG. 8 is a schematic plan view of the first anti-detachment member 600 according to an embodiment of the present disclosure; and FIG. 9 is a schematic front view of the first anti-detachment member 600 according to an embodiment of the present disclosure.

Referring to FIG. 6 to FIG. 9, the first anti-detachment member 600 according to an embodiment may include a slit 610 and a stopper 620.

The slit 610 is formed through the guide rail 300. The slit 610 may be provided in plural. In an embodiment, a plurality of slits 610 may be symmetrically disposed at opposite sides of the guide rail 300 in a width direction thereof. In an embodiment, the plurality of slits 610 may be arranged in plural rows in the longitudinal direction of the guide rail 300.

According to an embodiment, the slit 610 may include a first slit 611 and a second slit 612.

The first slit 611 may form an appearance of a side of the slit 610 and may extend in the first direction. According to an embodiment, the first slit 611 may penetrate a side surface of the guide rail 300 in the width direction of the guide rail 300, that is, in a direction parallel to the Y-axis with reference to FIG. 7. The first slit 611 may be disposed to have a longitudinal direction parallel to the first direction, that is, the Z-axis with reference to FIG. 7.

The first slit 611 may include a first end 611b connected to the second slit 612 described below and a second end 611a placed at an opposite side of the first end 611b.

The first end 611b and the second end 611a may be spaced apart from each other in a longitudinal direction of the first slit 611. The first end 611b may be disposed on a side surface of the guide rail 300 and may penetrate the side surface of the guide rail 300 in the Y-axis direction. The second end 611a may be placed on the sub-frame 200 and may penetrate the upper surface of the sub-frame 200 in the Z-axis direction. That is, the first slit 611 may extend such that a zone between the first end 611b and the second end 611a intersects a boundary region between the sub-frame 200 and the guide rail 300. Accordingly, the stopper 620 may enter the first slit 611 in the first direction through the second end 611a.

The second slit 612 may be connected to the first slit 611 and extend in a direction intersecting the first direction. According to an embodiment, the second slit 612 may penetrate the side surface of the guide rail 300 in the width direction of the guide rail 300, that is, in a direction parallel to the Y-axis. The second slit 612 may be disposed to have a longitudinal direction intersecting the first direction, that is, the longitudinal direction of the first slit 611. By way of example, the second slit 612 may be disposed such that the longitudinal direction of the second slit 612 is parallel to the longitudinal direction of the guide rail 300, as shown in FIG. 7. The second slit 612 may be connected at an end thereof to the first end 611b of the first slit 611.

In an embodiment, the second slit 612 may have a smaller width than the first slit 611. Accordingly, the second slit 612 may further reduce a rotatable extent of the fire extinguishing pipe 400 about the central axis thereof.

The stopper 620 protrudes from the heat detection member 500 toward the slit 610 and is inserted into the slit 610. According to an embodiment, the stopper 620 may have a columnar shape protruding from an outer surface of the heat detection member 500. Although FIG. 7 shows the stopper 620 having a circular cross-section, it is to be understood that the cross-sectional shape of the stopper 620 may have any of various shapes.

The stopper 620 may protrude from the heat detection member 500 in a direction intersecting the first direction. For example, the stopper 620 may be disposed to have a longitudinal direction parallel to a width direction of the stopper 500, that is, the Y-axis direction. A width of the stopper 620 may be smaller than the width of the slit 610, more specifically, the width of the first slit 611 and the second slit 612. Accordingly, the stopper 620 may be inserted into the slit 610 when the fire extinguishing pipe 400 is inserted into the guide rail 300.

The stopper 620 may be provided in plural. In an embodiment, a plurality of stoppers 620 may be symmetrically disposed at opposite sides of the heat detection member 500 in the width direction thereof. For example, as shown in FIG. 7, the stoppers 620 may be formed as a pair of stoppers, which may protrude in different directions from opposite sides of the heat detection member 500 in the width direction thereof. In this case, the stoppers 620 may be inserted into a pair of slits 610 disposed at opposite sides of the guide rail 300, respectively.

The energy storage system according to an embodiment may further include a second anti-detachment member 700.

The second anti-detachment member 700 is disposed outside the guide rail 300 to face the heat detection member 500. The second anti-detachment member 700 may secondarily prevent (prevent or substantially prevent) the fire extinguishing pipe 400 from being detached from the guide rail 300, such as when the function of the first anti-detachment member 600 is lost due to breakage of the stopper 620 or the like.

According to an embodiment, the second anti-detachment member 700 may be connected at a first end thereof to the sub-frame 200. A second end of the second anti-detachment member 700 may extend from the sub-frame 200 in the direction intersecting the first direction. By way of example, the second anti-detachment member 700 may extend from the sub-frame 200 in a direction parallel to the width direction of the guide rail 300.

The second anti-detachment member 700 may be disposed outside the guide rail 300 to face the open surface 301 in the first direction. That is, the second anti-detachment member 700 may be disposed to face the open surface 301 in an up and down manner. The second anti-detachment member 700 may be separated by a distance (e.g., a predetermined distance) from the open surface 301. When the fire extinguishing pipe 400 is inserted into the guide rail 300, the second anti-detachment member 700 may be disposed to face the seating surface 501 of the heat detection member 500. The second anti-detachment member 700 may contact the seating surface 501 to prevent (prevent or substantially prevent) detachment of the fire extinguishing pipe 400 when the fire extinguishing pipe 400 is detached from the guide rail 300 in a direction opposite to the first direction by an external force.

The second anti-detachment member 700 may be provided in plural. In an embodiment, a plurality of second anti-detachment members 700 may be symmetrically disposed at opposite sides of the guide rail 300. Further, the plurality of second anti-detachment members 700 may be arranged in plural rows in the longitudinal direction of the guide rail 300. The second anti-detachment members 700 may be spaced apart from the first anti-detachment member 600 in the longitudinal direction of the guide rail 300. When the stopper 620 is inserted into the first slit 611 in the first direction, the second anti-detachment member 700 may be disposed so as not to contact the fire extinguishing pipe 400 and the heat detection member 500.

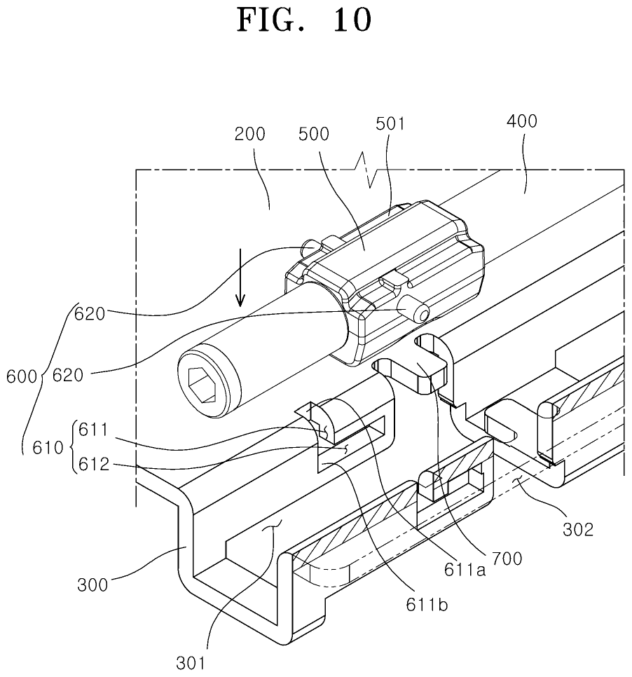

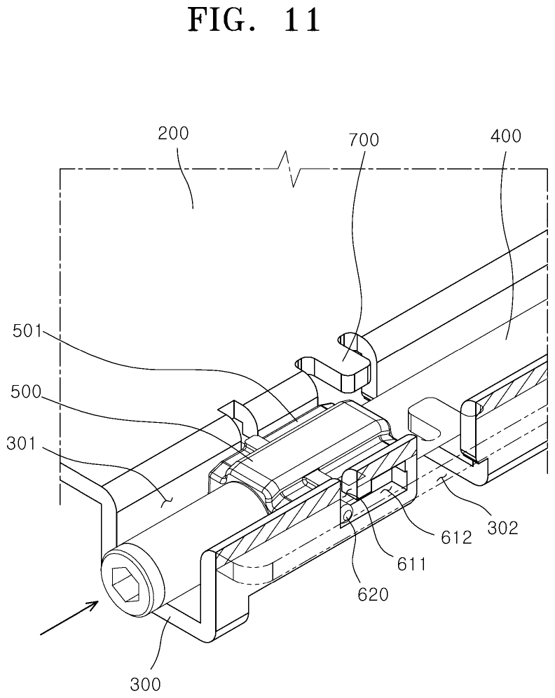

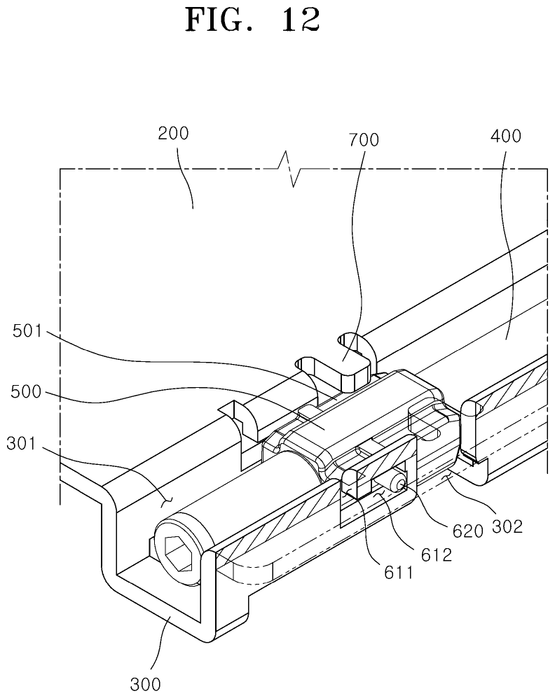

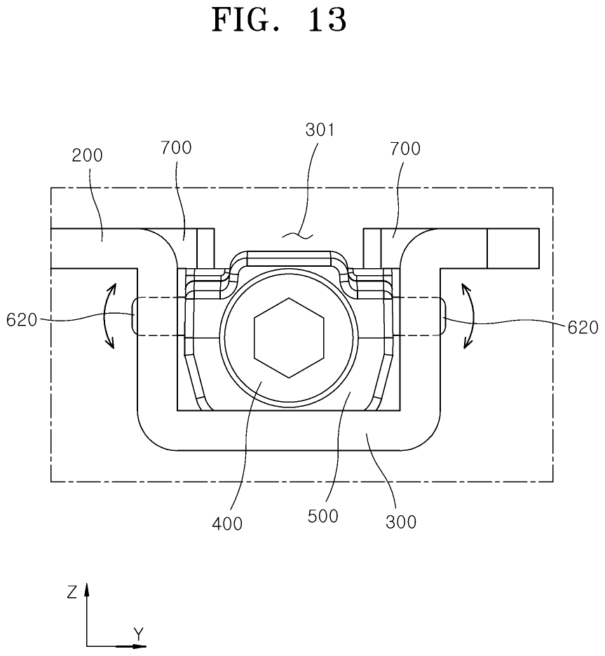

FIG. 10 to FIG. 12 are schematic views illustrating a process of assembling the fire extinguishing pipe 400 to the guide rail 300 in the energy storage system according to an embodiment of the present disclosure; and FIG. 13 is a view illustrating a state in which an external force is applied to the fire extinguishing pipe 400 in FIG. 12.

Referring to FIG. 10 to FIG. 12, the fire extinguishing pipe 400 is moved in the first direction while being disposed to face the open side 301 of the guide rail 300. In this case, the stopper 620 and the second end 611a of the slit 610 may be maintained facing each other in the first direction.

As the fire extinguishing pipe 400 is moved by a distance (e.g., a preset distance) or more in the first direction, the stopper 620 enters the first slit 611 through the second end 611a.

Thereafter, the stopper 620 is moved toward the first end 611b in the longitudinal direction of the first slit 611 and is placed at the first end 611b as the fire extinguishing pipe 400 is fully inserted into the guide rail 300.

Thereafter, the fire extinguishing pipe 400 is slidably moved in the

longitudinal direction of the guide rail 300, and the stopper 620 enters the second slit 612 through the first end 611b.

As the stopper 620 contacts an end of the second slit 612, movement of the fire extinguishing pipe 400 is stopped.

Referring to FIG. 13, when rotational force or torsional load is applied to the

fire extinguishing pipe 400 with the stopper 620 inserted into the second slit 612, the stopper 620 contacts an inner surface of the second slit 612.

The rotational force applied to the fire extinguishing pipe 400 is offset by a reaction force between the stopper 620 and the inner surface of the second slit 612, and the fire extinguishing pipe 400 can maintain its initial angle without rotating about the central axis thereof.

Further, when an external force is applied to the fire extinguishing pipe 400 in a direction opposite to the first direction with the stopper 620 inserted into the second slit 612, the stopper 620 contacts the inner surface of the second slit 612.

The external force applied to the fire extinguishing pipe 400 is offset by a reaction force between the stopper 620 and the inner surface of the second slit 612, and the fire extinguishing pipe 400 can maintain its initial position without moving in the direction opposite to the first direction.

When the fire extinguishing pipe 400 is moved in the direction opposite to the first direction due to breakage of the stopper 620, the second anti-detachment member 700 may contact the seating surface of the heat detection member 500 to secondarily prevent (prevent or substantially prevent) detachment of the fire extinguishing pipe 400 from the guide rail 300.

Herein, an energy storage system according to another embodiment of the present disclosure will be described.

The energy storage system according to another embodiment of the present disclosure may include a rack frame 100, a sub-frame 200, a guide rail 300, a fire extinguishing pipe 400, a heat detection member 500, a first anti-detachment member 600, and a second anti-detachment member 700.

The energy storage system according to an embodiment may differ from the energy storage system according to the previously described embodiment in a configuration of the first anti-detachment member 600. Accordingly, the following description will focus on the configuration of the

first anti-detachment member 600, which is not described above in the energy storage system according to the previously described embodiment of the present disclosure.

For the remaining configurations of the energy storage system according to the present embodiment, the description of the energy storage system according to the previously described embodiment of the present disclosure may be applied.

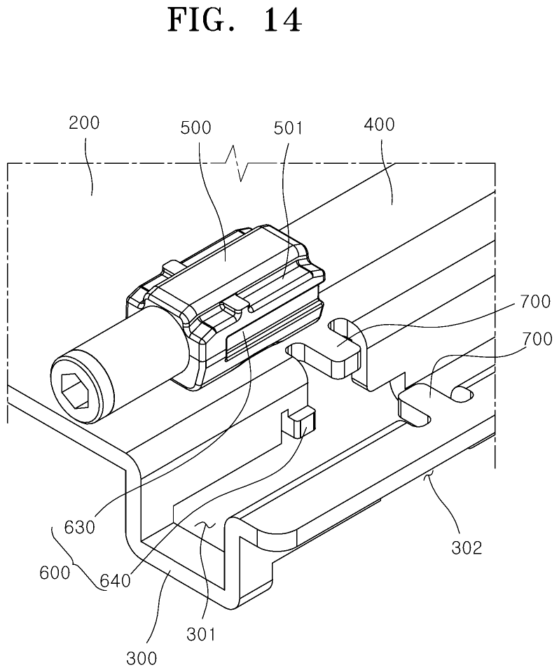

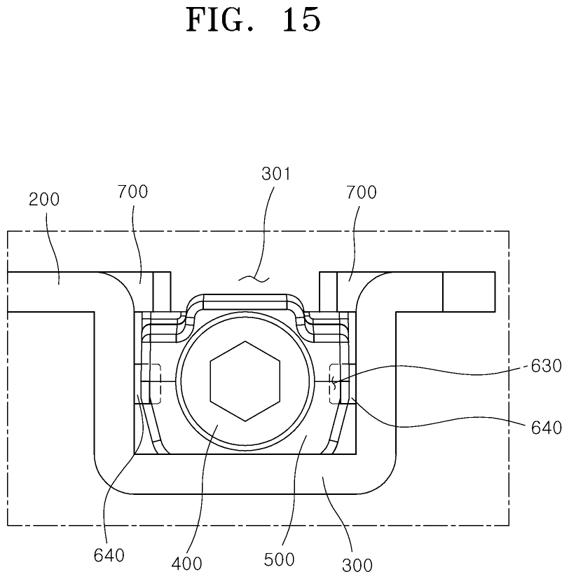

FIG. 14 is a schematic exploded perspective view of the first anti-detachment member according to another embodiment of the present disclosure; and FIG. 15 is a schematic plan view of the first anti-detachment member according to the embodiment shown in FIG. 14.

Referring to FIG. 14 and FIG. 15, the first anti-detachment member 600 according to an embodiment may include a groove 630 and a stopper 640.

The groove 630 may be concavely formed on an outer surface of the heat detection member 500. The groove 630 may be concavely recessed from a side surface of the heat detection member 500 that faces a side surface of the guide rail 300 in a width direction of the heat detection member 500, that is, in a direction parallel to the Y-axis direction with reference to FIG. 1.

The groove 630 may extend in a longitudinal direction of the heat detection member 500, that is, in a direction parallel to the X-axis direction with reference to FIG.

The groove 630 may have a smaller length than the heat detection member 500. In this case, a first end of the groove 630 may penetrate an end of the heat detection member 500 in the longitudinal direction thereof. Accordingly, the first end of the groove 630 may be open in the longitudinal direction of the heat detection member 500 and a second end of the groove 630 may be closed in the longitudinal direction thereof.

The groove 630 may be provided in plural. In an embodiment, a plurality of grooves 630 may be symmetrically disposed at opposite sides of the heat detection member 500 in the width direction thereof. For example, as shown in FIG. 14, the grooves 630 may be formed as a pair of grooves and may be recessed from opposite sides of the heat detection member 500 to face each other in the width direction thereof.

The stopper 640 may protrude from a side surface of the guide rail 300 toward an interior space of the guide rail 300. The stopper 640 may protrude from the side surface of the guide rail 300 in the width direction of the guide rail 300, that is, in in a direction parallel to the Y-axis direction with reference to FIG. 1. The stopper 640 may have a smaller width than the groove 630. Accordingly, the stopper 640 may be inserted into the groove 630 when the fire extinguishing pipe 400 is inserted into the guide rail 300.

The stopper 640 may be provided in plural. In an embodiment, a plurality of stoppers 640 may be symmetrically disposed at opposite sides of the guide rail 300 in the width direction thereof. The plurality of stoppers 640 may be arranged in plural rows in the longitudinal direction of the guide rail 300

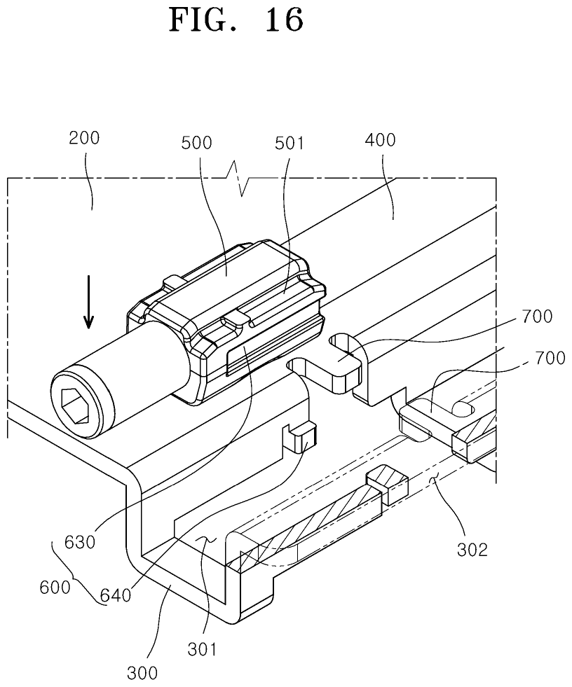

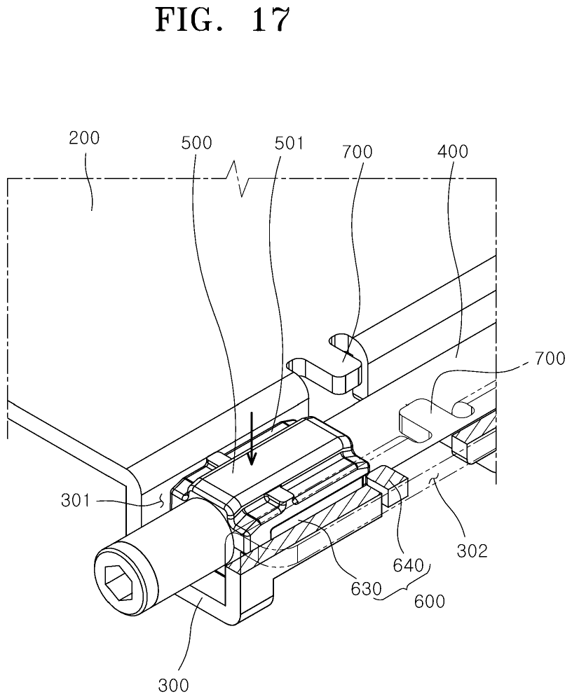

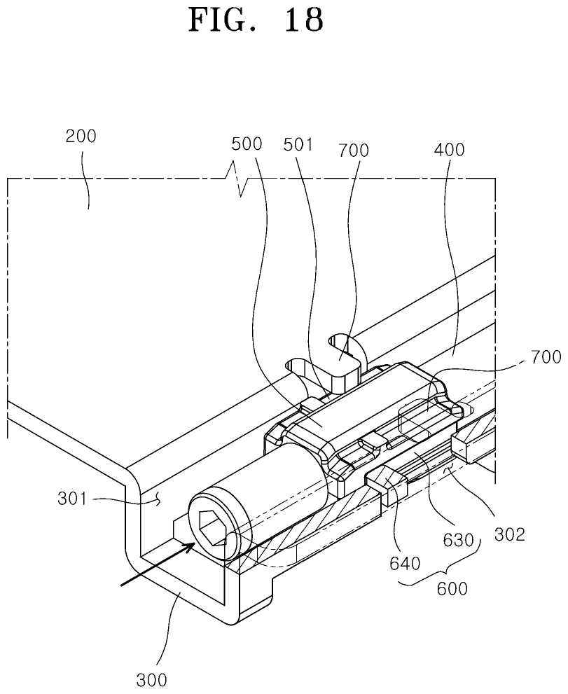

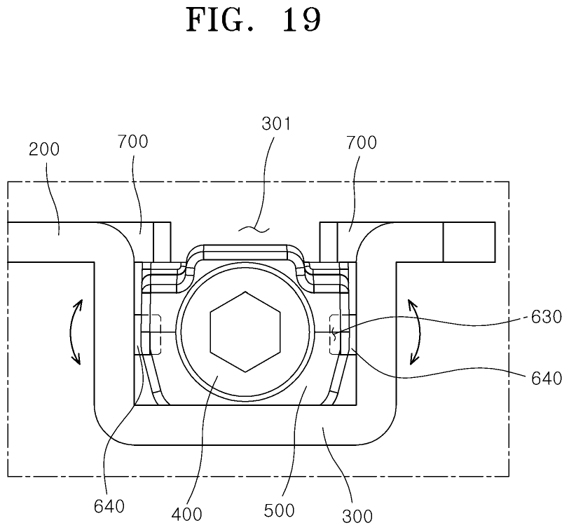

FIG. 16 to FIG. 18 are schematic views illustrating a process of assembling the fire extinguishing pipe 400 to the guide rail 300 in the energy storage system according to the embodiment shown in FIG. 14; and FIG. 19 is a view illustrating a state in which an external force is applied to the fire extinguishing pipe 400 shown in FIG. 18.

Referring to FIG. 16 to FIG. 18, the fire extinguishing pipe 400 is moved in the first direction while being disposed to face the open side 301 of the guide rail 300. In this case, a first end of the groove 630 and the stopper 640 may be kept alternating with each other in an intersecting direction with respect to the first direction.

As the fire extinguishing pipe 400 is fully inserted into the guide rail 300, the first end of the groove 630 and the stopper 640 are disposed to face each other in the longitudinal direction of the guide rail 300.

Thereafter, the fire extinguishing pipe 400 is slidably moved in the longitudinal direction of the guide rail 300, and the stopper 640 is inserted into the groove 630 through the first end of the groove 630.

As the fire extinguishing pipe 400 is moved by a distance (e.g., a preset distance) or more in the longitudinal direction of the guide rail 300, the stopper 640 contacts a second end of the groove 630 and sliding movement of the fire extinguishing pipe 400 is stopped.

Referring to FIG. 19, when a rotational force or torsional load is applied to the fire extinguishing pipe 400 with the stopper 640 inserted into the groove 630, the stopper 640 contacts an inner surface of the groove 630.

The rotational force applied to the fire extinguishing pipe 400 is offset by a reaction force between the stopper 640 and the inner surface of the groove 630, and the fire extinguishing pipe 400 can maintain its initial angle without rotating about the central axis thereof.

Further, when an external force is applied to the fire extinguishing pipe 400 in a direction opposite to the first direction with the stopper 640 inserted into the groove 630, the stopper 640 contacts the inner surface of the groove 630.

The external force applied to the fire extinguishing pipe 400 is offset by a reaction force between the stopper 640 and the inner surface of the groove 630, and the fire extinguishing pipe 400 can maintain its initial position without moving in the direction opposite to the first direction.

When the fire extinguishing pipe 400 is moved in the direction opposite to the first direction due to breakage of the stopper 640, the second anti-detachment member 700 may contact the seating surface of the heat detection member 500 to secondarily prevent (prevent or substantially prevent) the fire extinguishing pipe 400 from being detached from the guide rail 300.

Although the present disclosure has been described with reference to some example embodiments, it is to be understood by those skilled in the art that these embodiments are given by way of illustration, and that various modifications, variations, and alterations may be made without departing from the spirit and scope of the invention, and the scope of the invention should be construed by the claims and equivalents thereto.

1 what is claimed is:

1. An energy storage system comprising:
a rack frame accommodating battery modules;
a sub-frame secured to the rack frame and facing a battery module of the battery modules;
a guide rail concavely formed on a surface of the sub-frame;
a fire extinguishing pipe arranged within the guide rail and comprising a spray hole through which a fire extinguishing liquid is sprayable;
a heat detection member configured to surround the fire extinguishing pipe and open or close the spray hole in conjunction with a temperature variation; and
a first anti-detachment member arranged between the guide rail and the heat detection member to prevent the fire extinguishing pipe from being detached from the guide rail.

2. The energy storage system according to claim 1, wherein the first anti-detachment member comprises:
a slit formed through the guide rail; and
a stopper protruding from the heat detection member toward the slit and inserted in the slit.

3. The energy storage system according to claim 2, wherein the stopper has a smaller width than the slit.

4. The energy storage system according to claim 2, wherein the slit comprises a plurality of slits symmetrically arranged at opposite sides of the guide rail, and the stopper comprises a plurality of stoppers symmetrically arranged at opposite sides of the heat detection member.

5. The energy storage system according to claim 2, wherein
the fire extinguishing pipe is inserted into the guide rail through an open surface formed on the guide rail in a first direction, and
the slit comprises a first slit extending in the first direction, and a second slit connected to the first slit and extending in a direction intersecting the first direction.

6. The energy storage system according to claim 5, wherein the first slit comprises a first end connected to the second slit, and a second end opposite the first end and penetrating the sub-frame.

7. The energy storage system according to claim 5, wherein the second slit extends in a longitudinal direction of the guide rail.

8. The energy storage system according to claim 5, wherein the second slit has a smaller width than the first slit.

9. The energy storage system according to claim 1, wherein the first anti-detachment member comprises:
a groove concavely formed on an outer surface of the heat detection member; and
a stopper protruding from the guide rail and inserted in the groove.

10. The energy storage system according to claim 9, wherein the groove comprises a plurality of grooves symmetrically arranged at opposite sides of the heat detection member, and the stopper comprises a plurality of stoppers symmetrically arranged at opposite sides of the guide rail.

11. The energy storage system according to claim 9, wherein the stopper has a smaller width than the groove.

12. The energy storage system according to claim 9, wherein the groove extends in a longitudinal direction of the heat detection member.

13. The energy storage system according to claim 9, wherein the groove has a smaller length than the heat detection member.

14. The energy storage system according to claim 13, wherein an end of the groove penetrates an end of the heat detection member.

15. The energy storage system according to claim 1, further comprising a second anti-detachment member arranged outside the guide rail to face the heat detection member.

16. The energy storage system according to claim 15, wherein the first anti-detachment member is spaced apart from the second anti-detachment member in a longitudinal direction of the guide rail.

17. The energy storage system according to claim 15, wherein the second anti-detachment member comprises a plurality of second anti-detachment members symmetrically arranged at opposite sides of the guide rail.

18. The energy storage system according to claim 15, wherein the fire extinguishing pipe is inserted in the guide rail through an open surface formed on the guide rail in a first direction, and the open surface faces the second anti-detachment member in the first direction.

19. The energy storage system according to claim 18, wherein the second anti-detachment member extends from the sub-frame in a direction intersecting the first direction.
